(19) United States
(12) Patent Application Publication
(10) Pub. No.: US 2005/0163458 A1
(43) Pub. Date: Jul. 28, 2005

(54) Precision optical mount with reversible face plate

(76) Inventors: Millard A. Nunnally, Rainbow City, AL (US); Reed A. Farrar, Tustin, CA (US)

Correspondence Address: IRELL & MANELLA LLP, 840 NEWPORT CENTER DRIVE, SUITE 400, NEWPORT BEACH, CA, 92660, US

(21) Appl. No.: 10/958,312

(22) Filed: Oct. 4, 2004

Related U.S. Application Data
(60) Provisional application No. 60/538,537, filed on Jan. 23, 2004.

(51) Int. Cl. G02B 6/00

(52) U.S. Cl. 385/147

(57) ABSTRACT

An optical mount with a reversible face plate. The face plate supports an optical element. The face plate is reversible so that an optical element can be loaded from either the front or the rear of the optical mount. The mount includes a back plate and one or more actuators. The actuators can be manipulated to translate and/or tilt the face plate and the optical element. The actuators may engage flat pads attached to the face plate. The flat pads can be inserted into apertures on either side of the face plate. This allows the face plate to be reversed so that the optical element can be either front or rear loaded. The face plate may also have grooves located on each side of the plate to allow spring retention pins to be retained in either a front load or rear load position. The reversible feature of the face plate provides a single product that allows for both front loading and rear loading of an optical element.

### REFERENCE TO CROSS-RELATED APPLICATIONS

This application claims priority to Application No. 60/538,537 filed on Jan. 23, 2004.

### BACKGROUND OF THE INVENTION

1. Field of the Invention

The present invention relates to a reversible optical mount.

2. Background Information

Optical mounts are typically used to support an optical element used in an optical system. FIG. 1 shows an example of an optical mount 1 that has a face plate 2 and a back plate 3. The face plate 2 supports an optical element 4. The mount 1 includes a number of actuators 5 that can be manipulated by a user to translate or tilt the face plate 2 and the optical element 4. The optical mount shown is sold by the assignee of the present invention, Newport Corporation of Irvine, Calif.

The optical mount 1 is constructed to be either a front loaded mount, or a rear loaded mount. A front loaded optical mount allows the user to load the optical element from the front of the mount. This allows the user to readily swap out optical elements. With a rear loaded mount the optical element is held in place by kinematic stops that provide an accurate datum surface for the element. To obtain both the front mount and rear mount features the user must purchase two separate products. It would be desirable to provide a single optical mount that can be loaded from either the front or the rear of the mount.

### BRIEF SUMMARY OF THE INVENTION

An optical mount that includes a face plate and a back plate. The face plate includes a first surface and a second surface. Each surface has a kinematic locator. The mount further includes an actuator that extends through the back plate and engages the kinematic locator.

### BRIEF DESCRIPTION OF THE DRAWINGS

FIG. 1 is a front right perspective view of an optical mount of the prior art;

FIG. 2 is a side view of an optical mount of the present invention;

FIG. 3 is a rear view of the optical mount shown in FIG. 2;

FIG. 4 is an exploded view of the optical mount shown in FIG. 2;

FIG. 5 is a rear view of a face plate of the optical mount;

FIG. 6 is a sectional view of the face plate;

FIG. 7 is a graph showing a change in position of an optical element over a range of temperatures;

FIG. 8 is a rear view of the optical mount where an optical element has been rear loaded;

FIG. 9 is a side view of the optical mount shown in FIG. 8;

FIG. 10 is an exploded view of the rear loaded mount;

FIG. 11 is an exploded view of an alternate embodiment of an optical mount with lock nuts;

FIG. 12 is a side sectional view of the optical mount shown in FIG. 10;

FIG. 13 is an exploded view showing an alternate embodiment of an optical mount with micrometers/actuators.

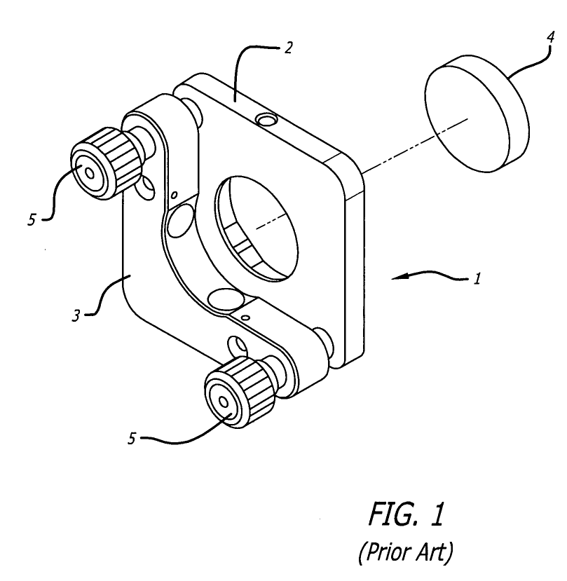

### DETAILED DESCRIPTION

Described is an optical mount with a reversible face plate. The face plate supports an optical element. The face plate is reversible so that an optical element can be loaded from either the front or the rear of the optical mount. The mount includes a back plate and one or more actuators. The actuators can be manipulated to translate and/or tilt the face plate and the optical element. The actuators may engage flat pads attached to the face plate. The flat pads can be inserted into apertures on either side of the face plate. This allows the face plate to be reversed so that the optical element can be either front or rear loaded. The face plate may also have grooves located on each side of the plate to allow spring retention pins to be retained in either a front load or rear load position. The reversible feature of the face plate provides a single product that allows for both front loading and rear loading of an optical element.

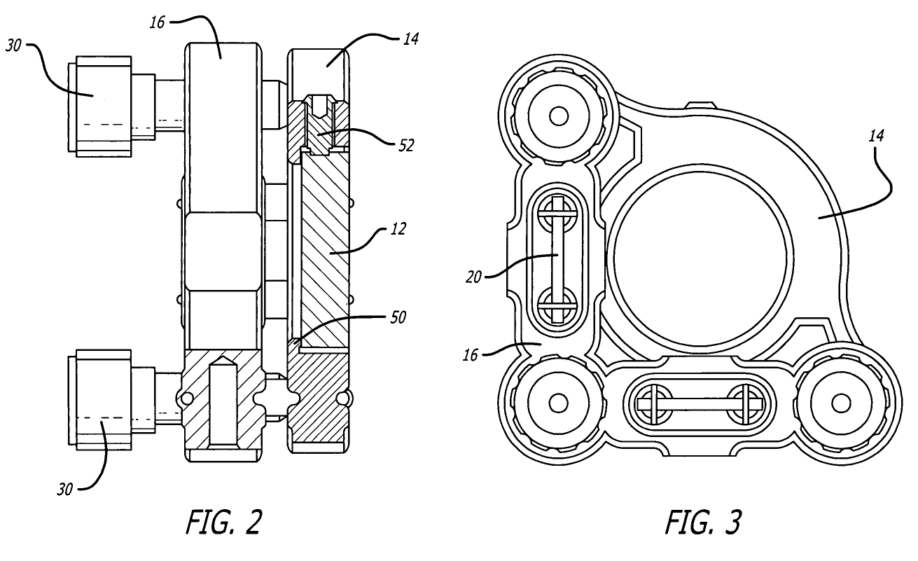

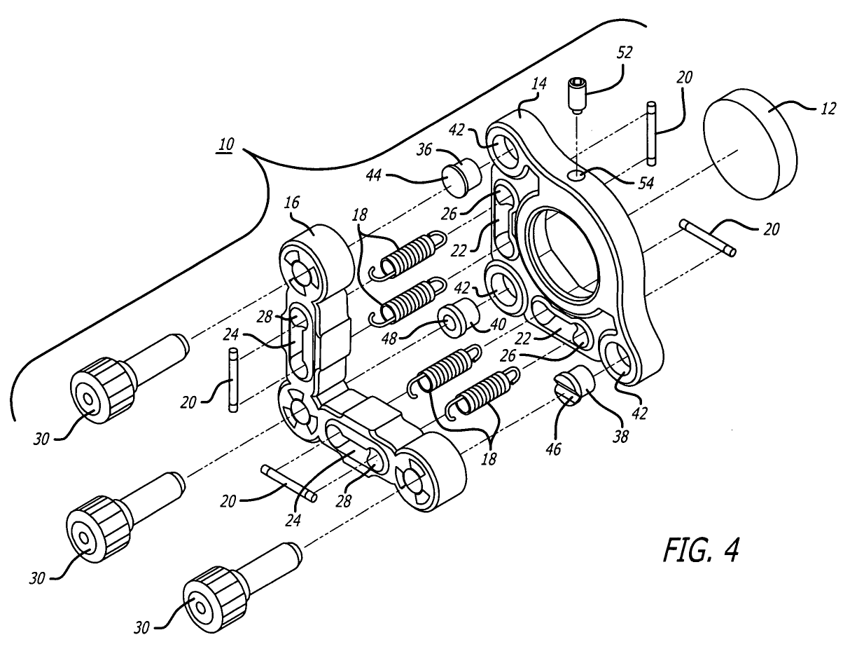

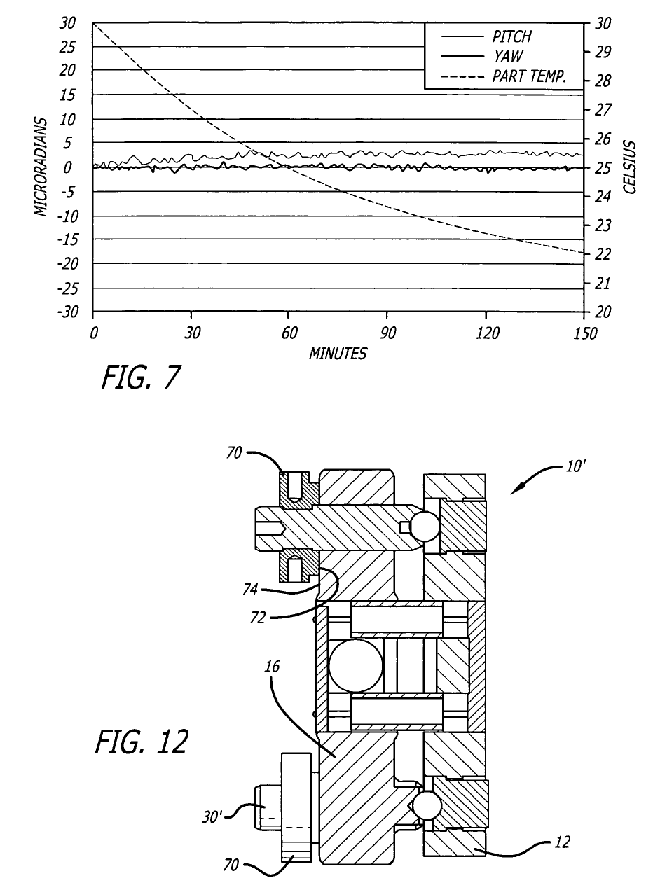

Referring to the drawings more particularly by reference numbers, FIGS. 2-6 show an embodiment of an optical mount 10 of the present invention. The optical mount shown in FIGS. 2-6 supports an optical element 12. FIGS. 2-6 show a front loaded optical element 12. The optical mount 10 includes a face plate 14 and a back plate 16. The plates 14 and 16 are preferably symmetric and constructed from a powdered sintered metal. By way of example, the powdered sintered metal may be a type 316 stainless steel with 0.5% Mn. The sintered metal and symmetric shape minimize thermal expansion of the plates 14 and 16, and movement of the optical element 12 during changes in temperature. FIG. 7 shows the movement of an optical element over a range of temperatures for an optical mount constructed from a powdered sintered metal. The powdered sintered material also provides a dull non-reflective outer surface that reduces the reflection of stray laser beams.

The optical mount 10 may include a plurality of springs 18 that coupled the face plate 14 to the back plate 16. The springs 18 may be captured by pins 20. The pins 20 may be located within grooves 22 of the face plate 14 and grooves 24 of the back plate 16. The grooves 22 and 24 may have thru holes 26 and 28, respectively to allow access for the springs 18.

The optical mount 10 includes a plurality of actuators 30 that extend through apertures 32 in the back plate 16. The actuators 30 engage flat pads 36, 38 and 40 that are attached to the face plate 14. The flat pads 36, 38 and 40 are inserted into corresponding apertures 42 of the face plate 14. Flat pad 36 may have a flat bearing surface 44 so that translational movement of the adjacent actuator causes corresponding translational movement of the face plate 14. The flat pad 38 may have a V-shaped groove 46 that engages a corresponding actuator and allows translational movement of the face plate 14. The flat pad 40 contains a conical shaped bore 48 that allows the face plate 14 to translate and pivot in response to translational movement of the adjacent actuator.

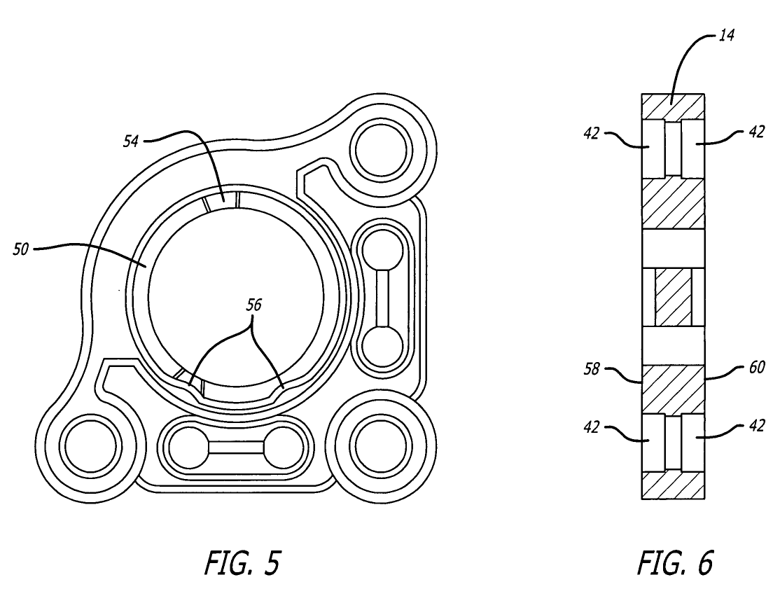

The face plate 14 may include a seat 50 that supports the optical element 12 (see FIGS. 2 and 5). The optical element 12 may be held in place by a fastener 52 that extends through an aperture 54 in the face plate 14. The seat 50 may include a pair of hard contacts 56 that support the optical element 12. The fastener 52 and hard contacts 56 create a 3-point kinematic support for the optical element 12.

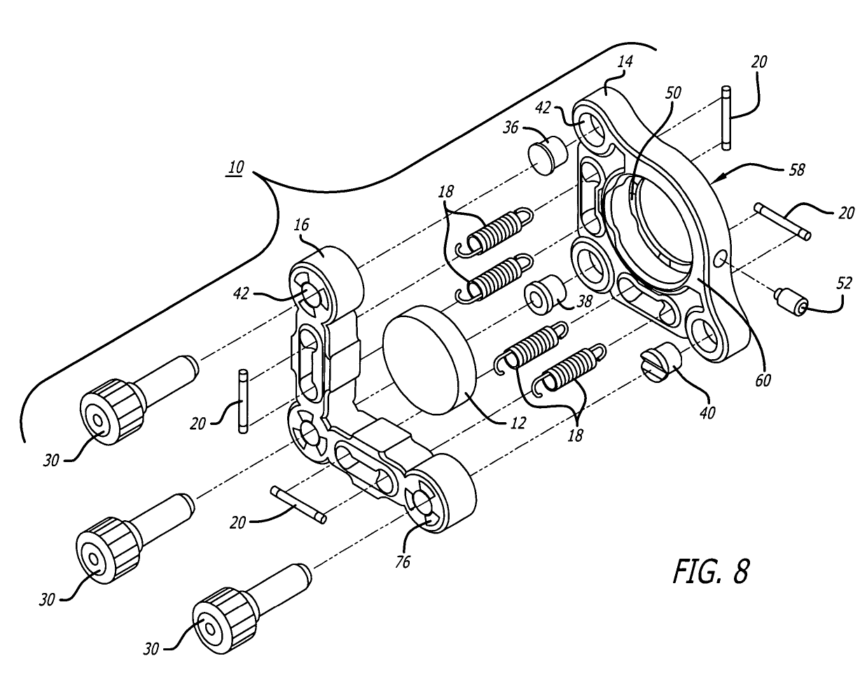

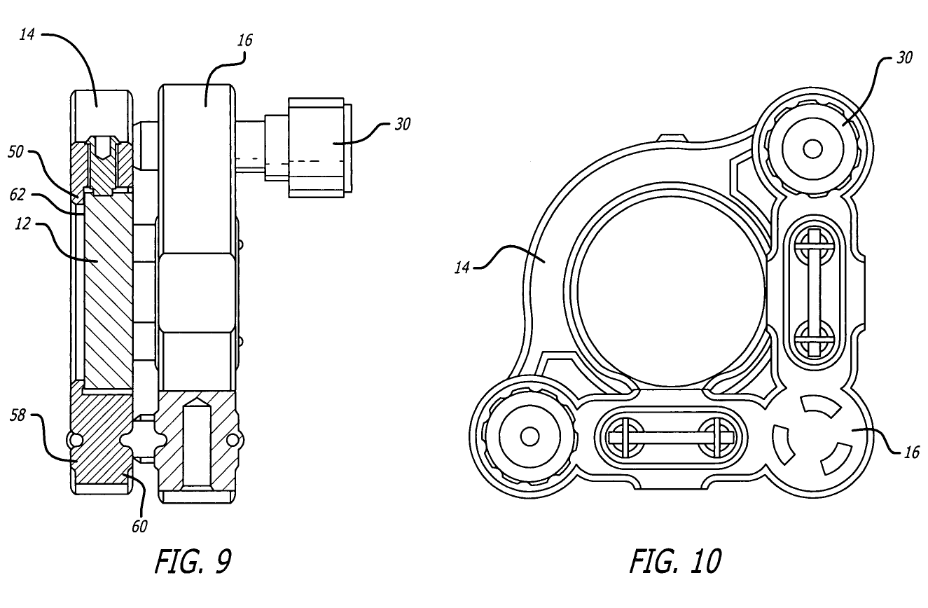

As shown in FIGS. 8-10 the optical mount 10 can be rearranged to allow for a rear loading of the optical element 12. The face plate 14 has apertures 42 located on both a first surface 58 and a second surface 60 (see also FIG. 6). The flat pads 36, 38 and 40 can be attached to the apertures 42 in either surface 58 or 60 so that the face plate 14 can be reversed. Likewise, both surfaces 58 and 60 contain grooves 22 for the spring pins 20 so that the face plate 14 can be reversed. With rear loading the seat 50 provides a controlled datum for the front surface 62 of the optical element 12. This can be particularly important if the optical element 12 is a mirror.

The optical mount 12 can be reversed by decoupling the pins 20 from the springs 18 and separating the face plate 14 from the back plate 16. The flat pads 36, 38 and 40 are removed from the apertures 42 of one face plate surface 58 or 60 and inserted into the apertures 42 of the other surface 60 or 58. The springs 18 and pins 20 are then re-assembled to the plates 14 and 16. For a rear loaded assembly the optical element 12 is typically mounted into the face plate 14 before the springs 18 and pins 20 are re-assembled to the plates 14 and 16.

Although an optical mount with flat pads 38 is shown and described, it is to be understood that the face plate 14 may have any type of kinematic locator that provides a bearing surface for the actuators 30. By way of example, the apertures 42 may not have a through hole so that there are counterbores on each surface 58 and 60 of the face plate 14. In this embodiment the actuators 30 can be seated directly into the counterbores, without using flat pads 36, 38 and 40.

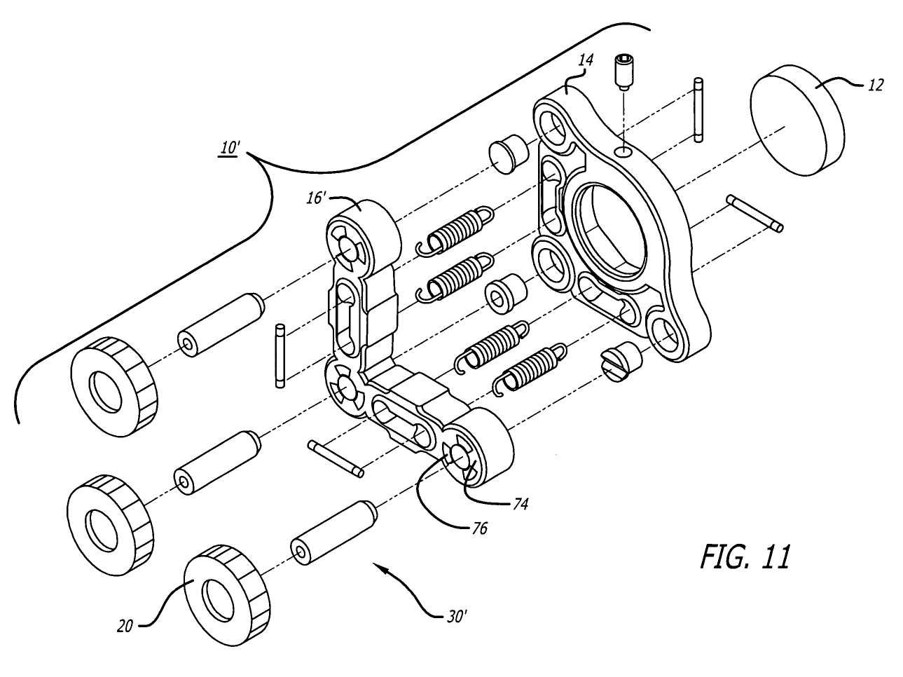

FIGS. 11 and 12 show an alternate embodiment of an optical mount 10′. The optical mount 10′ includes actuators 30′ that have locking nuts 70. The locking nuts 70 secure the position of the face plate 14 and prevent inadvertent movement of the optical element 12. When the face plate 14 is tilted, the front faces 72 of the locking nuts 70 may not be parallel with the adjacent surface 74 of the back plate 16. This may create distortions in the back plate. The back plate 16′ may have integral lock pads 76 that engage the locking nuts 70 and minimize distortion of the plate 16′. There are preferably three lock pads 76 to create a predictable three point kinematic contact for the lock nuts 70.

By way of example, the back plate 16 may be molded in a powdered sintered metal process and the lock pads 76 may be machined from the molded plate. Such a process is typically less expensive than machining the entire plate. Machining also allows for tight tolerances of the lock pads 76 in terms of flatness, and perpendicularity to the threads of the actuator screws.

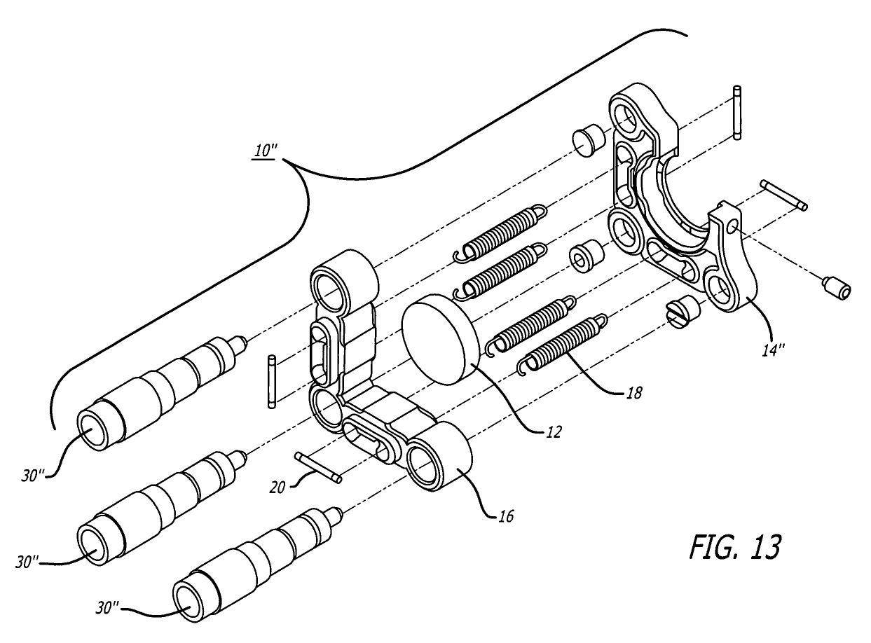

FIG. 13 shows another embodiment of an optical mount 10″. The actuators 34″ may be micrometers that provide fine adjustment of the face plate 14″ and optical element 12. In this embodiment the face plate 14″ may have a C-shape. The C-shape more readily allows a light beam to pass adjacent to the mount. C-shaped face plates are described in U.S. Pat. No. 6,304,393 issued to Sechrist et al. which is hereby incorporated by reference. Although the C-shaped face plate is shown in this embodiment, it is to be understood that C-shaped plates and other configuration disclosed in the '393 patent can be used in the other embodiments shown in FIGS. 2-6 and 8-12.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. An optical mount, comprising:
a face plate with a first surface and a second surface, said first and second surfaces each have a kinematic locator;
a back plate; and,
an actuator that extends through said back plate and engages said kinematic locator.

2. The optical mount of claim 1, wherein said face plate includes a seat with a pair of hard contacts.

3. The optical mount of claim 2, further comprising a fastener that extends through said seat of said face plate.

4. The optical mount of claim 1, further comprising a spring that is coupled to said face plate and said back plate.

5. The optical mount of claim 4, further comprising a pin that is located within a groove of said face plate and coupled to said spring.

6. The optical mount of claim 5, wherein first and second surfaces of said face plate each have a groove that can receive said pin.

7. The optical mount of claim 1, wherein said kinematic locator is a flat pad.

8. The optical mount of claim 7, wherein said flat pad includes a groove.

9. The optical mount of claim 7, wherein said flat pad includes a conically shaped hole.

10. The optical mount of claim 1, wherein said back plate includes a lock pad that engages a lock nut of said actuator.

11. The optical mount of claim 1, wherein said face plate is constructed from a powdered sintered metal.

12. An optical mount, comprising:
a back plate;
an actuator that extends through said back plate; and,
a face plate with a first surface and a second surface, said first and second surfaces having bearing means for engaging said actuator so that said face plate is reversible.

13. The optical mount of claim 12, wherein said face plate includes a seat with a pair of hard contacts.

14. The optical mount of claim 13, further comprising a fastener that extends through said seat of said face plate.

15. The optical mount of claim 12, further comprising a spring that is coupled to said face plate and said back plate.

16. The optical mount of claim 15, further comprising a pin that is located within a groove of said face plate and coupled to said spring.

17. The optical mount of claim 16, wherein first and second surfaces of said face plate each have a groove that can receive said pin.

18. The optical mount of claim 12, wherein said bearing means includes a flat pad.

19. The optical mount of claim 18, wherein said flat pad includes a groove.

20. The optical mount of claim 18, wherein said flat pad includes a conically shaped hole.

21. The optical mount of claim 12, wherein said back plate includes a lock pad that engages a lock nut of said actuator.

22. The optical mount of claim 12, wherein said face plate is constructed from a powdered sintered metal.

23. A method for reversing an optical mount, comprising:
decoupling a back plate from a face plate that has a first kinematic locator on a first surface and is engaged with an actuator;
reversing the face plate; and,
coupling the back plate to the face plate so that the actuator engages a second kinematic locator located on a second surface of the face plate.

24. The method of claim 23, further comprising detaching a flat pad from the first surface and attaching the flat pad to the second surface of the face plate.

25. The method of claim 23, attaching an optical element to the face plate.

26. An optical mount, comprising:
a face plate constructed from a powdered sintered metal;
a back plate coupled to said face plate; and,
an actuator that extends through said back plate and is coupled to said face plate.

27. The optical mount of claim 26, wherein said face plate includes a seat with a pair of hard contacts.

28. The optical mount of claim 27, further comprising a fastener that extends through said seat of said face plate.

29. The optical mount of claim 26, further comprising a spring that is coupled to said face plate and said back plate.

30. The optical mount of claim 29, further comprising a pin that is located within a groove of said face plate and coupled to said spring.

31. The optical mount of claim 26, further comprising a flat pad that is attached to said face plate and engages said actuator.

32. An optical mount, comprising:
a face plate;
a back plate coupled to said face plate, said back plate having a plurality of lock pads; and,
an actuator that extends through said back plate and is coupled to said face plate, said actuator engages said lock pads.

33. The optical mount of claim 32, wherein said actuator includes a lock nut that engages said lock pads.

34. The optical mount of claim 32, wherein there are three lock pads.

35. The optical mount of claim 32, wherein said back plate is constructed from a powdered sintered metal.

36. An optical mount, comprising:
a face plate;
an actuator that moves said face plate; and,
a back plate that is coupled to said face plate and supports said actuator, said back plate having means for creating a three point contact with said actuator.

37. The optical mount of claim 36, wherein means includes a plurality of lock pads and said actuator includes a lock nut that engages said lock pads.

38. The optical mount of claim 37, wherein there are three lock pads.

39. The optical mount of claim 36, wherein said back plate is constructed from a powdered sintered metal.

40. A method for constructing a back plate for an optical mount, comprising:
molding a back plate;
machining at least one lock pad from the molded back plate.

41. The method of claim 40, wherein the back plate is molded with a powdered sintered metal.
